(19) United States
(12) Patent Application Publication
(10) Pub. No.: US 2026/0067739 A1
(43) Pub. Date: Mar. 5, 2026

(54) DYNAMICALLY ENABLING VOICE OVER NEW RADIO WITH NEW RADIO BANDS

(71) Applicant: GOOGLE LLC, Mountain View, CA (US)

(72) Inventor: Chi-Wen Chung, San Diego, CA (US)

(21) Appl. No.: 19/012,241

(22) Filed: Jan. 7, 2025

Related U.S. Application Data
(60) Provisional application No. 63/688,641, filed on Aug. 29, 2024.

(51) Int. Cl. H04W 28/02; H04L 5/00; H04W 28/18

(52) U.S. Cl. CPC H04W 28/0215; H04L 5/0048; H04W 28/18

(57) ABSTRACT

A user equipment device in a cellular network implements one or more mechanisms to dynamically manage Voice over New Radio (VoNR). These one or more mechanisms include the UE device monitoring for at least one VoNR related parameter from the cellular network based on a device configuration implemented by the UE device. Then, responsive, to the VoNR related parameter and the device configuration, the UE device dynamically enables a VoNR feature for at least one New Radio band.

### BACKGROUND

Voice over New Radio (VoNR) is a technology that enables voice services directly over Fifth Generation (5G) New Radio (NR) networks. This advancement, defined by the Third Generation Partnership Project (3GPP), represents a step toward fully integrated 5G communication systems. By leveraging the capabilities of 5G NR, VoNR eliminates the reliance on legacy networks such as 3GPP Long-Term Evolution (LTE) or circuit-switched fallback mechanisms, providing a seamless and efficient voice communication experience.

Despite its potential, the deployment of VoNR has introduced challenges due to its phased and non-uniform rollout across different NR frequency bands and geographical regions. As a result, user equipment (UE) devices encounter issues when moving between cells that support VoNR and those that do not. These challenges include increased call setup latency caused by Evolved Packet System Fallback (EPSFB), failed handovers during transitions from Wi-Fi to NR networks, and VoNR call failures due to the network's inability to assign necessary resources or handle signaling errors effectively.

### SUMMARY OF EMBODIMENTS

In accordance with one aspect, a method at a user equipment (UE) device of a cellular network is provided. The method includes monitoring for at least one Voice over New Radio (VoNR)-related parameter from the cellular network based on a device configuration implemented by the UE device, and dynamically enabling a VoNR feature for a first New Radio (NR) band in response to the VoNR related parameter and the device configuration.

In at least some embodiments, the method further includes disabling the VoNR feature in response to the UE device camping on a second NR band.

In at least some embodiments, monitoring for the at least one VoNR related parameter includes monitoring, upon powering up the UE device, at least one of one or more network identifiers or band information. Dynamically enabling the VoNR feature comprises responding to a determination that conditions for enabling the VoNR feature are satisfied based on comparing the at least one of one or more network identifiers or band information to the device configuration.

In at least some embodiments, dynamically enabling the VoNR feature includes dynamically enabling the VoNR feature only for one or more NR bands supported by at least one specific carrier while excluding one or more NR bands known to have performance issues.

In at least some embodiments, dynamically enabling the VoNR feature further includes dynamically enabling the VoNR feature for multiple supported NR bands when the UE device camps simultaneously on those NR bands.

In at least some embodiments, the method further includes disabling the VoNR feature in response to the UE device moving from the first NR band that supports VONR to a second NR band that does not support VONR and initiating a fallback mechanism.

In at least some embodiments, the method further includes re-enabling the VoNR feature when the UE device returns to an NR band that supports VONR.

In accordance with another aspect, a user equipment (UE) device is provided. The UE device includes one or more radio frequency (RF) modems configured to wirelessly communicate with at least one network, one or more processors coupled to the one or more RF modems, and at least one memory storing executable instructions. The executable instructions are configured to manipulate at least one of the one or more processors or the one or more RF modems to monitor for at least one VoNR related parameter from the cellular network based on a device configuration implemented by the UE device, and dynamically enable a VoNR feature for a first NR band in response to the VoNR related parameter and the device configuration.

In at least some embodiments, the executable instructions are further configured to manipulate the at least one of the one or more processors or the one or more RF modems to disable the VoNR feature in response to the UE device camping on a second NR band.

In at least some embodiments, monitoring for the at least one VoNR related parameter includes monitoring, upon powering up the UE device, at least one of one or more network identifiers or band information. Dynamically enabling the VoNR feature includes responding to a determination that conditions for enabling the VoNR feature are satisfied based on comparing the at least one of one or more network identifiers or band information to the device configuration.

In at least some embodiments, dynamically enabling the VoNR feature includes dynamically enabling the VoNR feature only for one or more NR bands supported by at least one specific carrier while excluding one or more NR bands known to have performance issues.

In at least some embodiments, dynamically enabling the VoNR feature further includes dynamically enabling the VoNR feature for multiple supported NR bands when the UE device camps simultaneously on those NR bands.

In at least some embodiments, the executable instructions are further configured to manipulate the at least one of the one or more processors or the one or more RF modems to disable the VoNR feature in response to the UE device moving from the first NR band that supports VONR to a second NR band that does not support VoNR and initiate a fallback mechanism.

In at least some embodiments, the executable instructions are further configured to manipulate the at least one of the one or more processors or the one or more RF modems to re-enable the VoNR feature when the UE device returns to an NR band that supports VONR.

In a further aspect, a method at a user equipment (UE) device of a cellular network is provided. The method includes monitoring, upon powering up the UE device, at least one of one or more network identifiers or band information broadcast by the cellular network, comparing at least one of one or more network identifiers or band information to a device configuration implemented by the UE device to determine whether a specific carrier supports VONR for one or more specific NR bands, dynamically enabling the VoNR feature in response to determining that the specific carrier supports VONR for the one or more specific NR bands and that the at least one of one or more network identifiers or band information satisfy at least one condition for enabling the VoNR feature, and disabling the VoNR feature in response to the UE device transitioning to an NR band that does not satisfy the at least one condition for enabling the VoNR feature.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram illustrating an example wireless system employing a UE device configured to dynamically manage Voice over New Radio (VoNR) in accordance with some embodiments.

FIG. 2 is a block diagram illustrating example configurations for dynamic VoNR management employed by a UE device of FIG. 1 in accordance with some embodiments.

FIG. 3 is a diagram illustrating an example hardware configuration of a UE device of FIG. 1 in accordance with some embodiments.

FIG. 4 is a ladder (signaling) diagram illustrating an example sequence of operations between the UE device and networks of FIG. 1 for dynamically managing VoNR in accordance with some embodiments.

FIG. 5 is a flow diagram illustrating an example method for dynamically managing VoNR at a UE device of FIG. 1 in accordance with some embodiments.

### DETAILED DESCRIPTION

As networks gradually roll out VoNR support, a growing number of user equipment (UE) devices are being equipped with VoNR capabilities to take advantage of this new feature. However, the phased and non-uniform deployment of VoNR across different NR bands has introduced significant challenges when UE devices move between NR bands that support VoNR and those that do not.

In current real-world network environments, a VoNR-capable device only supports the VoNR feature in specific cells (i.e., those where the VoNR service is available). This selective support leads to several issues as the UE device transitions between different 5G cells. Notably, when a UE device enters a cell that lacks VoNR capability, an EPS Fallback (EPSFB) call is often triggered, which results in increased call latency and degrades the overall user experience.

Furthermore, the absence of VoNR support in certain cells can cause failures during handovers from Wi-Fi to NR networks. In such scenarios, the network may send a non-access stratum (NAS) transport message with an error cause, leading to unsuccessful handovers and potential service interruptions for the user. Additionally, VoNR call failures have been observed when the network fails to assign the necessary Data Radio Bearer (DRB) for audio, or when it responds with a SIP 503 service unavailable message upon receiving a SIP INVITE message from the UE device.

As such, the following describes embodiments of systems and methods for dynamically enabling VoNR. The UE device, in at least some embodiments, includes various configurations for determining and enabling the supporting operating bands of a VoNR feature in a specific carrier. For example, in one configuration, the UE device checks the inserted subscriber identity module (SIM) to enable the VoNR feature and enables the VoNR feature on all NR band(s) that the specific carrier supports. In another configuration, the UE device dynamically determines whether to enable the VoNR feature by monitoring network and band information upon powering on. The device enables VoNR only for specific NR bands supported by the carrier and switches to fallback mechanisms when moving to bands that lack VoNR support. The feature is re-enabled when the device returns to a VoNR-capable band. In a further configuration, the UE device compares the NR band information with its configuration to selectively enable VONR. This approach ensures optimized call performance by activating VoNR on mature bands, such as the commonly supported N78, while triggering fallback mechanisms for unsupported bands.

For ease of illustration, the following techniques are described in an example context in which one or more UEs and one or more RANs implement at least a Fourth Generation (4G) Long-Term Evolution (3GPP LTE) standard (e.g., 3GPP Release 8, Release 9, Release 10, etc.) or a Fifth Generation (5G) New Radio (NR) standard (e.g., 3GPP Release 13, 3GPP Release 16, 3GPP Release 17, etc.) (hereinafter, “5G NR” or “5G NR standard”). However, it should be understood that the present disclosure is not limited to networks employing an LTE or 5G NR RAT configuration, but rather, the techniques described herein can be applied to any RAT employed at the UEs, and the RANs that implement Radio Resource Management Mobility operations are an equivalent thereof. It should also be understood that the present disclosure is not limited to any specific network configurations or architectures described herein for VoNR management modes at UEs for relaxing RRM activities. Instead, techniques described herein can be applied to any configuration of RANs. Also, the present disclosure is not limited to the examples and context described herein, but rather, the techniques described herein can be applied to any network environment where a UE implements VONR management modes at a UE for relaxing RRM activities.

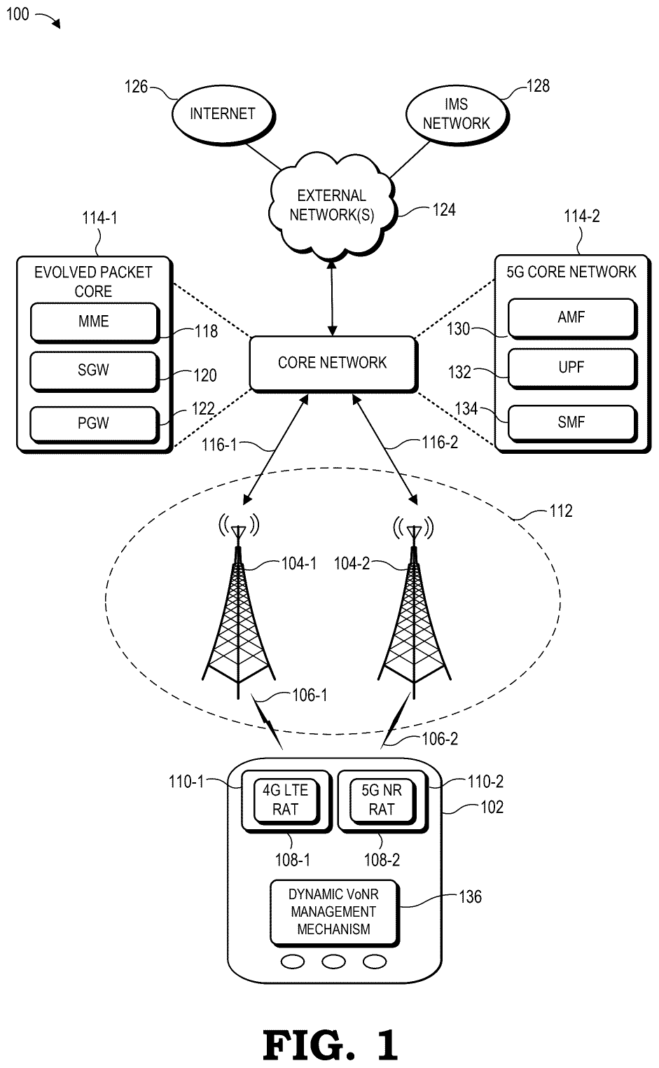

FIG. 1 illustrates a mobile cellular network 100 (also referred to here as “cellular network 100” or “network 100”) in accordance with at least some embodiments. As shown, the mobile cellular network 100 includes a device, such as a user equipment (UE) device 102, that is configured to communicate with one or more base stations (BSs) 104 (illustrated as BS 104-1 and BS 104-2) through one or more wireless communication links 106 (illustrated as wireless links 106-1 and 106-2). The UE device 102, in at least some embodiments, includes any of a variety of wireless communication devices, such as a cellular phone, a cellular-enabled tablet computer or cellular-enabled notebook computer, a cellular-enabled wearable device, an automobile, or other vehicle employing cellular services (e.g., for navigation, provision of entertainment services, in-vehicle mobile hotspots, etc.), and so on. In at least some embodiments, the UE device 102 employs a single RAT 108. In other embodiments, the UE device 102 is a multi-mode UE that employs multiple RATs 108 (illustrated as RAT 108-1 and RAT 108-2). Examples of multiple RATs include cellular-based RATs, such as a 3GPP Long-Term Evolution (3GPP LTE) RAT, a 3GPP Fifth Generation New Radio (5G NR) RAT, a WLAN RAT, and the like. It should be understood that although FIG. 1 only shows the UE device 102 implementing two different RATs 108, the UE device 102, in at least some implementations, implements three or more different RATs 108. In at least some embodiments, one or more RAT modules 110 (illustrated as RAT module 110-1 and RAT module 110-2) manage the RATs 108 and enable communication between the UE device 102 and the radio access technology of the network 100. The one or more RAT modules 110, in at least some embodiments, include one or more of a modem chipset(s) of the UE device 102, a protocol stack(s), driver software, and the like.

In at least some embodiments, the BSs 104 are implemented in a macrocell, microcell, small cell, picocell, and the like, or any combination thereof. Examples of base stations 104 include an Evolved Universal Terrestrial Radio Access Network Node B (E-UTRAN Node B), Evolved Node B (eNodeB or eNB), Next Generation (NG or NGEN) Node B (gNode B or gNB), and so on. The BSs 104 communicate with the UE device 102 via the wireless links 106, which are implemented using any suitable type of wireless link. The wireless links 106, in at least some embodiments, include a downlink of data and control information communicated from the base stations 104 to the UE device 102, an uplink of data and control information communicated from the UE device 102 to the BSs 104, or both. In at least some embodiments, the wireless links 106 (or bearers), such as data radio bearers (DRBs) and signal radio bearers (SRBs), are implemented using any suitable communication protocol or standard, or combination of communication protocols or standards, such as 3GPP 4G LTE, 5G NR, and so on. In at least some embodiments, multiple wireless links 106 are aggregated in a carrier aggregation to provide a higher data rate for the UE device 102. Also, multiple wireless links 106 from multiple BSs 104 are configured, in at least some embodiments, for coordinated multipoint (COMP) communication with the UE device 102, as well as dual connectivity, such as single-RAT LTE-LTE or NR-NR dual connectivity or multi-radio access technology (Multi-RAT) dual connectivity (MR-DC) including E-UTRA-NR dual connectivity (EN-DC), NGEN radio access network (RAN) E-UTRA-NR dual connectivity (NGEN-DC), and NR E-UTRA dual connectivity (NE-DC).

The BSs 104 collectively form a Radio Access Network (RAN) 112, such as an E-UTRAN or 5G NR RAN. The base stations 104 are connected to a core network (CN) 114 (illustrated as CN 114-1 and CN 114-2) via control-plane and user-plane interfaces through one or more links 116 (illustrated as link 116-1 and link 116-2). Depending on the configuration of the mobile cellular network 100, the core network 114 is either an Evolved Packet Core (EPC) network 114-1 or a 5G Core Network (5GC) 114-2. For example, in an E-UTRAN configuration or a 5G non-standalone (NSA) EN-DC configuration, the core network 114 is an EPC network 114-1 that includes, for example, a Mobility Management Entity (MME) 118, a Serving Gateway (SGW) 120, and a Packet Data Network Gateway (PGW) 122. The MME 118 provides control-plane functions, such as registration and authentication of multiple UEs 102, authorization, mobility management, and so on. The SGW 120 transfers user-plane packets related to audio calls, video calls, Internet traffic, and the like. The PGW 122 provides connectivity from the UE device 102 to external packet data networks 124, such as the Internet 126 and an Internet Protocol Multimedia Subsystem (IMS) network 128, by being the point of exit and entry of traffic for the UE device 102. In a 5G standalone (SA) configuration or an NSA NE-DC or NGEN-DC configuration, the core network 114 is a 5GC network 114-2. The 5GC 114-2 includes, for example, an Access and Mobility Management function (AMF) 130, a User Plane Function (UPF) 132, and a Session Management Function (SMF) 134. The AMF 130 provides control-plane functions such as registration and authentication of multiple UEs 102, authorization, mobility management, and so on. The UPF 132 transfers user-plane packets related to audio calls, video calls, Internet traffic, and the like. The SMF 134 manages protocol data unit (PDU) sessions.

In at least some embodiments, the core network 114 communicatively couples the UE device 102 to an IMS network 128 via the RAN 112. The IMS network 128 provides various IMS services to the UE device 102, such as IMS short messages, IMS unstructured supplementary service data (USSD), IMS value-added service data, IMS supplementary service data, IMS voice calls, and IMS video calls. To this end, an entity (e.g., a server or a group of servers) operating in the IMS network 128 supports packet exchange with the UE device 102. The packets convey signaling (such as session initiation protocol (SIP) messages, IP messages, or other suitable messages) as well as data (or media), such as voice or video. In at least some embodiments, the IMS network includes entities (not shown) such as a Proxy Call Session Control Function (P-CSCF), an Interrogating Call Session Control Function (I-CSCF), a Serving Call Session Control Function (S-CSCF), a Home Subscriber Server (HSS), a Media Gateway Control Function (MGCF), and the like.

As described above, optimizing user experience at a UE device 102 involves balancing advanced functionality with efficient power and feature management, particularly in the context of dynamically enabling VoNR capabilities. The phased and non-uniform deployment of VoNR across different NR bands introduces challenges such as increased call latency, handover failures, and service interruptions when transitioning between supported and unsupported bands. To address these challenges, the UE device 102, in one or more embodiments, employs mechanisms to detect and adapt to varying network capabilities. For example, the UE device 102 integrates at least one dynamic VoNR management mechanism 136 that robustly detects the availability of VoNR in the current NR band. This detection enables the UE device 102 to transition seamlessly between VoNR-supported and fallback modes, conserving resources while maintaining service continuity.

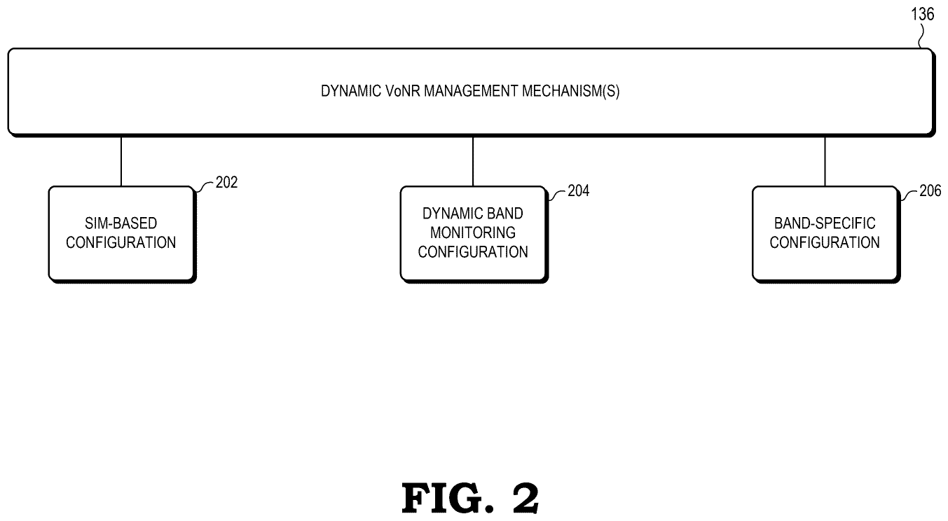

FIG. 2 illustrates various example configurations employed singularly or in various combinations by the UE device 102 as part of the dynamic VoNR management mechanism 136 in accordance with at least some embodiments. These configurations, in at least some embodiments, include a SIM-based configuration 202, a dynamic band monitoring configuration 204, and a band-specific configuration 206. The VoNR management mechanism 136 implements any of these configurations independently or depending on whether specific carrier or network conditions are satisfied.

In the SIM-based configuration 202, the dynamic VoNR management mechanism 136 determines the VoNR capability based on the inserted SIM card. In this configuration, the VoNR management mechanism 136 enables VoNR for all NR bands supported by the carrier associated with the SIM. For instance, if the SIM indicates support for NR bands N41, N71, and N25, the UE device 102 enables VoNR on these bands unless restricted by other configurations or network conditions.

In the dynamic band monitoring configuration 204, the dynamic VoNR management mechanism 136 monitors the Mobile Country Code (MCC), Mobile Network Code (MNC), and the NR bands listed in the System Information Block (e.g., SIB1) to dynamically decide whether to enable VoNR. For example, if a carrier supports NR bands N41, N71, and N25 but experiences issues on N25, this configuration ensures that VoNR is enabled only on N41 and N71. When the UE device 102 moves from an NR band that supports VONR (e.g., N41 or N71) to a band that does not (e.g., N25), the VoNR feature is temporarily disabled, and fallback mechanisms like Evolved Packet System Fallback (EPSFB), are triggered. The dynamic VoNR management mechanism 136 re-enables VoNR when the UE device 102 returns to a VoNR-capable band (e.g., N41 or N71).

In the band-specific configuration 206 is implemented when the UE device 102 monitors only the NR bands listed in the SIB1 and compares them with the device's configuration to determine whether to enable VoNR. This configuration ensures VoNR is enabled on specific, mature NR bands that provide reliable call performance. For example, if N78 is identified as a commonly supported NR band for VoNR globally, the UE device 102 enables VoNR only on N78. In this scenario, VoNR is triggered when the UE device 102 camps on N78. Otherwise, fallback mechanisms, such as EPSFB, are initiated when the UE device 102 camps on unsupported bands.

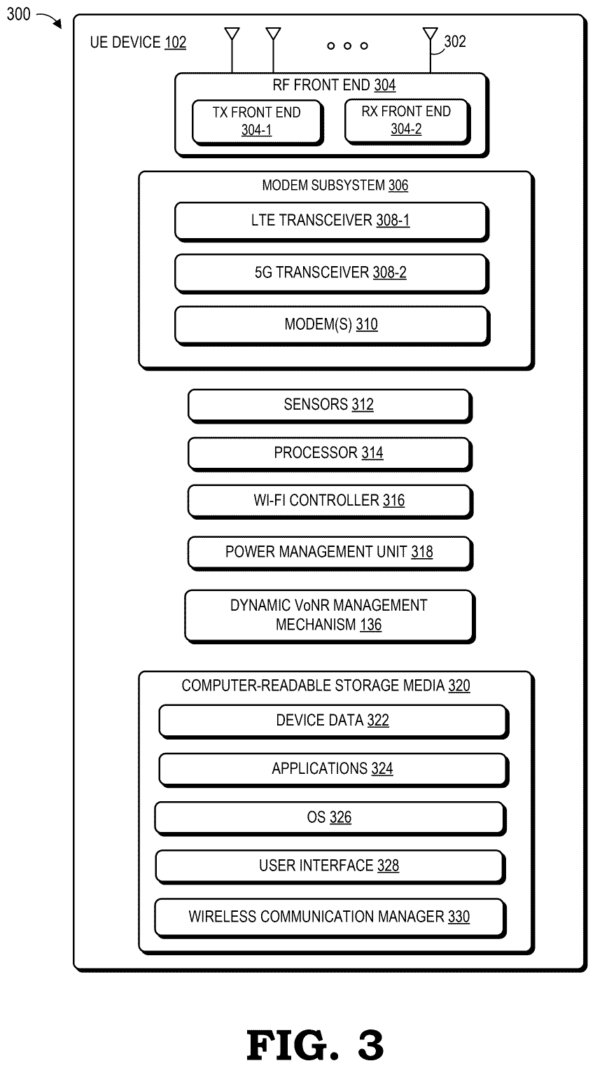

FIG. 3 illustrates an example device diagram 300 of a UE device 102. In at least some embodiments, the device diagram 300 describes a UE that implements the VoNR management techniques described herein. The UE device 102 may include additional functions and interfaces that are omitted from FIG. 3 for the sake of clarity. The UE device 102, in at least some embodiments, includes antennas 302, a radio frequency (RF) front end 304, and a modem subsystem 306. The modem subsystem 306 includes multiple transceivers 308 (e.g., a 3GPP 4G LTE transceiver 308-1 and a 5G NR transceiver 308-2) for communicating with one or more base stations 104 in a RAN 112, such as a 5G RAN, an E-UTRAN, a combination thereof, and so on. The modem subsystem 306 also includes a cellular modem 310 (also referred to as a baseband processor or a communication processor) that is responsible for managing the operations of the transceivers 308. In at least some embodiments, the modem 310 is implemented as a modem baseband processor, software-defined radio module, configurable modem (e.g., multi-mode, multi-band modem), wireless data interface, wireless modem, or so on. The modem 310 supports, for example, one or more of data access, messaging, or data-based services of a wireless network, as well as various audio-based communication (e.g., voice calls).

The RF front end 304, in at least some embodiments, includes a transmitting (Tx) front end 304-1 and a receiving (Rx) front end 304-2. The Tx front end 304-1 includes components such as one or more power amplifiers (PA), drivers, mixers, filters, and so on. The Rx front end 304-2 includes components such as low-noise amplifiers (LNAs), mixers, filters, and so on. The RF front end 304, in at least some embodiments, couples or connects the modem subsystem 306, including the LTE transceiver 308-1 and the 5G NR transceiver 308-2, to the antennas 302 to facilitate various types of wireless communication.

In at least some embodiments, the antennas 302 of the UE device 102 include an array of multiple antennas configured similarly to or different from each other. The antennas 302 and the RF front end 304, in at least some embodiments, are tuned to or are tunable to one or more frequency bands, such as those defined by the 3GPP LTE, 3GPP 5G NR, IEEE Wireless Local Area Network (WLAN), IEEE Wireless Metropolitan Area Network (WMAN), or other communication standards. In at least some embodiments, the antennas 302, the RF front end 304, and the transceivers 308 are configured to support beamforming (e.g., analog, digital, or hybrid) or In-Phase and Quadrature (I/Q) operations (e.g., I/Q modulation or demodulation operations) for the transmission and reception of communications with one or more base stations 104. By way of example, the antennas 302 and the RF front end 304 operate in sub-gigahertz bands, sub-6 GHz bands, above 6 GHz bands, or a combination of these bands defined by the 3GPP LTE, 3GPP 5G NR, or other communication standards.

In at least some embodiments, the antennas 302 include one or more receiving antennas positioned in a one-dimensional shape (e.g., a line) or a two-dimensional shape (e.g., a triangle, a rectangle, or an L-shape) for implementations that include three or more receiving antenna elements. While the one-dimensional shape enables the measurement of one angular dimension (e.g., an azimuth or an elevation), the two-dimensional shape enables two angular dimensions to be measured (e.g., both azimuth and elevation). Using at least a portion of the antennas 302, the UE device 102 can form beams that are steered or un-steered, wide or narrow, or shaped (e.g., as a hemisphere, cube, fan, cone, or cylinder). The one or more transmitting antennas may have an un-steered omnidirectional radiation pattern or may produce a wide steerable beam. Either of these techniques enables the UE device 102 to transmit a radio signal to illuminate a large volume of space. In some embodiments, the receiving antennas generate thousands of narrow steered beams (e.g., 2000 beams, 4000 beams, or 6000 beams) with digital beamforming to achieve desired levels of angular accuracy and angular resolution.

The UE device 102, in at least some embodiments, includes one or more sensors 312 implemented to detect various properties such as one or more of temperature, supplied power, power usage, battery state, or the like. Examples of sensors include a thermal sensor, a battery sensor, a power usage sensor, and so on.

The UE device 102 also includes at least one processor 314. The processor 314, in at least some embodiments, is a single-core processor or a multiple-core processor composed of a variety of materials, such as silicon, polysilicon, high-K dielectric, copper, and so on. In at least some embodiments, the processor 314 is implemented at least partially in hardware, including, for example, components of an integrated circuit or a System-on-a-Chip (SoC), a Digital-Signal-Processor (DSP), an Application-Specific Integrated Circuit (ASIC), a Field-Programmable Gate Array (FPGA), a Complex Programmable Logic Device (CPLD), other implementations in silicon or other hardware, or a combination thereof. Examples of the processor(s) 314 include a communication processor if not implemented within the modem subsystem 306), an application processor, microprocessors, DSPs, controllers, and so on. An application processor, in at least some embodiments, provides computing resources to applications executing on the UE device 102. For example, an application provides a self-contained operating environment that delivers system capabilities (e.g., graphics processing, memory management, and multimedia processing) to support applications executing on the UE device 102.

The UE device 102, in at least some embodiments, further includes a Wi-Fi controller 316, which is responsible for managing the device's connection to Wi-Fi networks. The Wi-Fi controller 316 handles tasks such as scanning for available networks, establishing and maintaining Wi-Fi connections, and managing data transmission over Wi-Fi. The UE device 102 interacts with the modem subsystem 306 and other components to coordinate network access and ensure seamless switching between Wi-Fi and cellular networks. The Wi-Fi controller 316, in at least some embodiments, is implemented as an integrated circuit (IC), either part of an SoC, or as a discrete component within the UE device 402.

The UE device 102 further includes a power management unit (PMU) 318, which is responsible for managing power distribution across the various components of the UE device 102, including the RF front end 304, the modem subsystem 306, and the modem 310. The PMU 318 optimizes power usage by adjusting the power levels supplied to different components based on their operational state, ensuring that power consumption is minimized during periods of low activity or when certain components are disabled, such as when specific RATs are deprioritized or disabled based on the RAT selection techniques described herein. The PMU 318 also manages battery charging and ensures efficient power delivery to components when needed. In at least some embodiments, the PMU 318 is implemented as an IC that is either part of an SoC or as a discrete component within the UE device 102.

The UE device 102 further includes a non-transitory computer-readable storage media 320 (CRM 320). The computer-readable storage media described herein excludes propagating signals. The CRM 320, in at least some embodiments, includes any suitable memory or storage device such as random-access memory (RAM), static RAM (SRAM), dynamic RAM (DRAM), non-volatile RAM (NVRAM), read-only memory (ROM), or Flash memory useable to store device data 322 of the UE device 102. In at least some embodiments, the device data 322 includes user data, multimedia data, beamforming codebooks, applications 324, an operating system 326 of the UE device 102, a user interface(s) 328, and so on, which are executable by the processor(s) 314 to enable user-plane communication, control-plane signaling, and user interaction with the UE device 102. The user interface 328, in at least some embodiments, is configured to receive inputs from a user of the UE device 102, such as to receive input from a user that defines and or facilitates one or more aspects of adverse radio link condition detection. In at least some embodiments, the user interface 328 includes a graphical user interface (GUI) that receives the input information via a touch input. In other instances, the user interface 328 includes an intelligent assistant that receives the input information via an audible input or speech. Alternatively, or additionally, the operating system 326 of the UE device 102 is maintained as firmware or an application on the CRM 320 and executed by the processor(s) 314.

The CRM 320, in at least some embodiments, further includes a communication manager 330. Alternatively, or additionally, the communication manager 330, in at least some embodiments, is implemented in whole or part as hardware logic or circuitry integrated with or separate from other components of the UE device 102. In at least some embodiments, the communication manager 330 configures the RF front end 304, the LTE transceiver 308-1, the 5G NR transceiver 308-2, or a combination thereof to perform one or more wireless communication operations.

The UE device 102 also the includes the dynamic VoNR management mechanism 136 described herein. The dynamic VoNR management mechanism 136, in at least some embodiments, is implemented in whole or part as hardware logic or circuitry integrated with or separate from other components of the UE device 102. In other embodiments, one or more portions of the dynamic VoNR management mechanism 136 are implemented in the CRM 320.

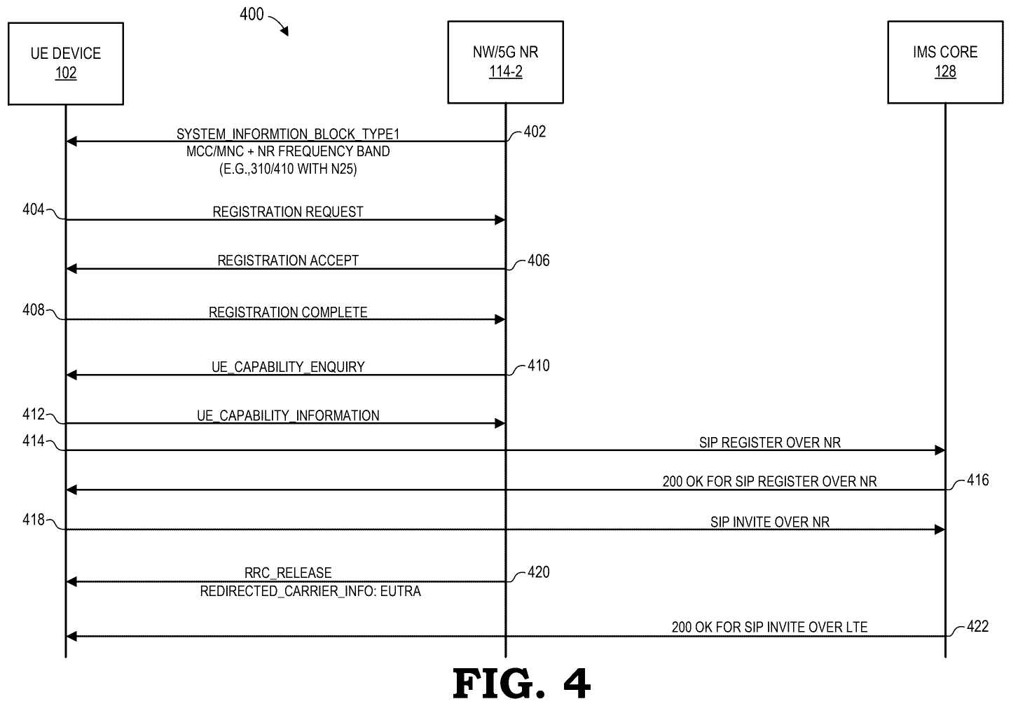

FIG. 4 illustrates a ladder (signaling) diagram 400 depicting an example interactions between the UE device 102, the core network 114 (e.g., 5G NR network), and the IMS core 128, demonstrating the dynamic management of VoNR capabilities across various configurations, including the SIM-based configuration 202, the dynamic band monitoring configuration 204, and the band-specific configuration 206. These configurations work independently or in combination to ensure VoNR is enabled or fallback mechanisms are triggered, depending on the network and carrier conditions.

The process begins with the UE device 102 receiving systemInformationBlockType1 (SIB1) 402 from the 5G NR network. This SIB1 402 includes details, such as the Mobile Country Code (MCC), Mobile Network Code (MNC), and the NR frequency bands available in the network (e.g., 310/410 with N25). In the dynamic band monitoring configuration 204, the UE device 102 uses this information to identify whether VoNR can be enabled for the specific carrier or band. The UE device 102 evaluates the MCC and MNC to determine the carrier's identity and matches it with its preconfigured database of carrier capabilities. Additionally, the UE device 102 parses the NR band information to assess whether the current band is listed as supporting VoNR based on the carrier's provisioning or network deployment status. For instance, if the SIB1 402 indicates that the current NR band is N41, the UE device 102 identifies this as a VoNR-capable band for certain carriers, while N25 may be flagged as problematic or unsupported due to known network issues.

Similarly, in the band-specific configuration 206, the UE device 102 compares the received NR band information against its internal configuration to selectively enable VoNR for mature bands (e.g., N78) while avoiding problematic or unsupported bands. The internal configuration includes, for example, a predefined list of mature bands that are globally or regionally recognized for stable VoNR operation. For example, N78 may be identified as a reliable band with widespread VoNR support, making it a priority for VoNR enablement. The UE device 102 dynamically cross-references the SIB1 band information with this internal list and activates VoNR only if the band meets maturity criteria, such as extensive carrier deployment and minimal known issues. Conversely, if the NR band in the SIB1 402 (e.g., N25) is flagged internally as problematic due to intermittent connectivity or high failure rates, the UE device 102 disables VoNR and prepares fallback mechanisms, such as EPSFB, to ensure seamless voice services. This approach ensures that VoNR is enabled only under optimal conditions, enhancing user experience and minimizing disruptions.

Next, the UE device sends a Registration request 404 to the network 114 over the current NR band to initiate the registration process. In the SIM-based configuration 202, this request 404 reflects the carrier's SIM-related support for VoNR across the indicated NR bands. The network 114 responds with a Registration accept message 406, confirming the UE's eligibility to proceed. This action validates that the SIM-associated NR bands or dynamically determined bands support VONR, depending on the configuration in use.

Following the acceptance, the UE device 102 completes the registration process by sending a Registration complete message 408 to the network 114. At this point, the dynamic VoNR management mechanism 136, in at least some implementations, enables VoNR for the relevant bands based on the chosen configuration. The UE device 102 enables and disables VoNR for bands by interacting with its internal modem 310 and protocol stack. For example, in the dynamic band monitoring configuration 204, the UE device 102 sends configuration commands to its modem 310 to activate VoNR on NR bands dynamically identified as stable, such as N41 or N71. This activation involves, for example, updating the modem's band-specific configuration to establish Data Radio Bearers (DRBs) for voice traffic over NR, enabling the SIP REGISTER process for VoNR, and configuring the IMS layer to use NR for call signaling and media traffic.

Conversely, for bands (e.g., N25) that exhibit performance issues, the UE device 102 disables VoNR by modifying the modem's configuration to exclude those bands from VoNR-capable operations. This includes, for example, preventing DRB establishment for voice services on N25, disabling a feature tag (FT), such as voiceoverNR, in ueCapabilityInformation message, and redirecting voice services to fallback mechanisms, such as LTE through EPSFB. The UE device 102 also updates the internal band status flags to reflect whether VoNR is supported or unsupported for each band in real time.

In the band-specific configuration 206, VoNR is selectively enabled only on mature bands, such as N78, to ensure optimal call performance. The UE device 102 performs this by referencing its internal configuration database, which lists mature NR bands, and then sending corresponding enablement or disablement commands to the modem 310. For mature bands, such as N78, VoNR is enabled by, for example, establishing DRBs, initiating ueCapabilityInformation with voiceoverNR FT for VONR, and configuring the IMS layer to prioritize NR for call handling. For unsupported or immature bands, the UE device 102, disables VoNR by, for example, blocking the activation of VoNR-specific resources and ensuring fallback mechanisms are prepared to handle voice traffic. These processes ensure that VoNR is only active under optimal conditions, enhancing call quality and user experience.

The network 114 then initiates a ueCapabilityEnquiry 410 to query the UE device 102 for its capabilities, including VoNR support. The UE device 102 responds with ueCapabilityInformation 412, listing its VONR capabilities and supported bands. In the SIM-based configuration 202, this response reflects the capabilities provisioned by the carrier via the inserted SIM. In the band-specific configuration 206, the capability information highlights VoNR readiness for mature bands like N78. The dynamic band monitoring configuration 204 is not explicitly addressed in this step because it focuses on dynamically monitoring real-time network conditions, such as MCC, MNC, and NR band details from SIB1, rather than reporting static capabilities. In conventional methods, VoNR support is statically indicated in the ueCapabilityInformation message through the inclusion or exclusion of the voiceoverNR feature tag. In contrast, the techniques described herein dynamically manage VoNR activation based on real-time conditions, allowing for more adaptive and efficient behavior.

Also, at this step, the UE device 102 removes the voiceoverNR FT based on its analysis of real-time network conditions, ensuring VoNR is only activated under reliable circumstances. This autonomous adjustment by the UE device 102 ensures it dynamically optimizes VoNR functionality, avoids unnecessary fallback scenarios, and aligns with observed network conditions. The removal of FTs by the UE device 102 ensures that VoNR is activated only when stable voice services can be supported, while fallback mechanisms like EPSFB remain available for non-VoNR-capable bands.

Subsequently, the UE device 102 sends a SIP REGISTER over NR request 414 to the IMS core 128, as part of its standard IMS registration process, regardless of whether VoNR is supported. In the dynamic band monitoring configuration 204, the UE device 102 dynamically determines VoNR support and includes the voiceoverNR feature tag (FT) in the ueCapabilityInformation message to indicate to the network whether VoNR is supported. Similarly, in the band-specific configuration 206, the capability information reflects VoNR readiness for mature bands. The IMS core 128 responds with a 200 OK message 416 for SIP REGISTER over NR, confirming successful 5G call registration, such as VoNR or EPSFB.

When the UE device 102 initiates a voice call, the UE device 102 sends a SIP INVITE over NR request 418 to the IMS core 128. This request ensures VoNR or EPSFB is leveraged for call initiation, provided the current band supports it. If the network 114 determines that the current NR band no longer supports VoNR, the network 114 issues a rrcRelease message 420 to the UE device 102, signaling the release of the Radio Resource Control (RRC) connection and initiating a redirection process. In the dynamic band monitoring configuration 204, this action triggers fallback mechanisms, such as EPSFB, when the UE device 102 moves to a non-VoNR-capable band, such as. Similarly, in the band-specific configuration 206, fallback is initiated for unsupported bands to maintain call continuity.

In at least some embodiments, the network 114 provides a redirectedCarrierInfo: eutra message (along with or in addition to the rrcRelease message 420) instructing the UE device 102 to move to LTE for voice services. This ensures seamless service transitions when VoNR is unavailable. Finally, the IMS core 128 confirms the call setup over LTE by responding with 200 OK message 422 for SIP INVITE over LTE. This fallback mechanism ensures uninterrupted voice services, regardless of VoNR availability on the current NR band.

As such, the dynamic VoNR management techniques described herein provide substantial advantages by enabling VoNR only under reliable conditions and dynamically adapting to network and carrier-specific factors. Through configurations such as the SIM-based configuration 202, dynamic band monitoring configuration 204, and band-specific configuration 206, the UE device 102 and the network 114 work independently or in combination to optimize VoNR functionality. By selectively enabling VoNR on mature bands, such as N78, and disabling VoNR on problematic bands, such as N25, these techniques enhance call quality, reduce latency, and maintain seamless service continuity. The removal or adjustment of the voiceoverNR FT by the UE device 102 ensures efficient VoNR utilization while fallback mechanisms like EPSFB provide uninterrupted voice services when VoNR is unavailable. These approaches collectively balance performance, energy efficiency, and reliability, making them well-suited for dynamic and evolving 5G NR network environments.

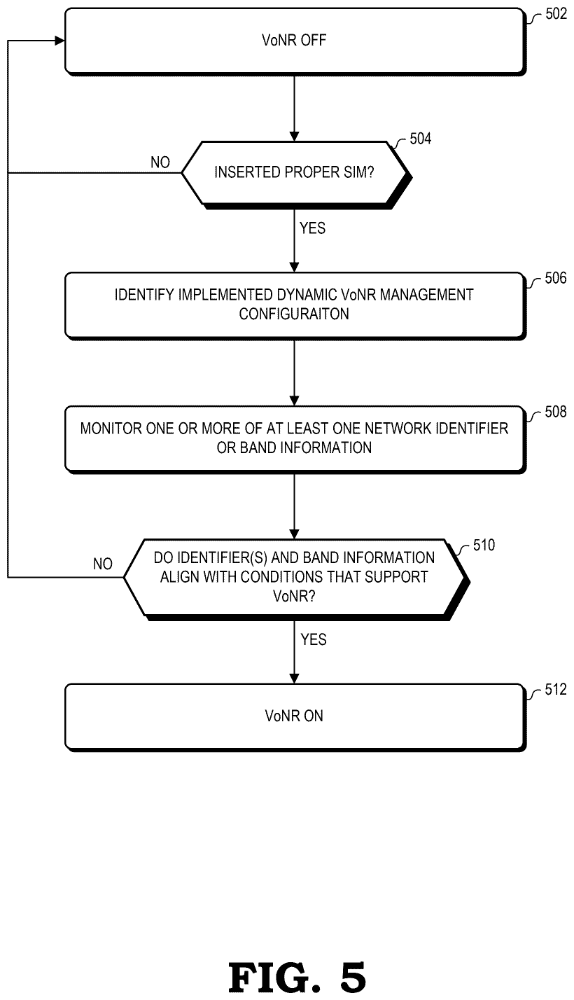

FIG. 5 illustrates a flow diagram of a method 500 for dynamically managing VoNR at a UE device 102. The processes described below with respect to method 500 are detailed further with reference to FIGS. 1 through 4 above. For purposes of description, the method 500 is described with respect to an example implementation of the UE device 102 illustrated in FIG. 1 and FIG. 3, but it will be appreciated that, in other implementations, the method 500 is performed within systems with different configurations of the UE device 102. Furthermore, the method 500 is not limited to the sequence of operations shown in FIG. 5, as at least some operations can occur in parallel or in a different sequence. Additionally, in at least some implementations, the method 500 can include one or more different operations beyond those depicted in FIG. 5.

At block 502, the UE device 102 begins in a state where VoNR is off. This initial state ensures that the device conserves resources until the conditions for enabling VoNR are validated. The decision to proceed depends on subsequent evaluations of one or more of an inserted SIM, a network condition(s), or NR band suitability, as outlined in the various configurations (e.g., the SIM-based configuration 202, a dynamic band monitoring configuration 204, and a band-specific configuration 206 described above). At block 504, the UE device 102 determines whether a proper SIM has been inserted. This step aligns with the SIM-based configuration 202, where the capabilities provisioned by the carrier via the inserted SIM are used to enable VoNR. If the inserted SIM is valid and supports VONR, the process moves forward. If not, the UE device 102 loops back to the VoNR-off state, ensuring VoNR is not activated without proper provisioning.

At block 506, the UE device 102 selects which configuration to apply. Depending on the scenario, the UE device 102 may use the SIM-based configuration 202 to rely on carrier-provisioned data, the dynamic band monitoring configuration 204 to dynamically evaluate real-time network conditions, or the band-specific configuration 206 to prioritize globally mature bands for VoNR activation. This decision guides how the subsequent steps are performed. At block 508, the UE device 102 monitors network information, including the MCC, MNC, and NR band(s) details received from the 5G NR network (e.g., via SIB1). This process corresponds to the dynamic band monitoring configuration 204, where the UE device 102 actively evaluates real-time data to determine if VoNR can be supported under current conditions. This dynamic monitoring ensures that VoNR activation is responsive to the specific carrier and network environment.

At block 510, the UE device 102 evaluates whether the monitored MCC/MNC and NR band(s) align with conditions that support VONR. For the dynamic band monitoring configuration 204, this involves dynamically assessing whether the current MCC/MNC and NR band(s) support reliable VoNR operation. For the band-specific configuration 206, this process focuses on determining if the NR band is part of the internal list of globally mature bands, such as N78, which are known for stable VoNR operation. If the conditions are satisfied, the process moves forward to enable VONR. If not, the UE device 102 loops back to the VoNR-off state to conserve resources and rely on fallback mechanisms when necessary.

At block 512, the UE device 102 enables VoNR if the conditions are met. For the SIM-based configuration 202, VoNR is activated based on carrier provisioning from the SIM. For the dynamic band monitoring configuration 204, VoNR is dynamically enabled on bands identified as stable through real-time monitoring. For the band-specific configuration 206, VoNR is selectively enabled only for globally mature bands that meet predefined criteria for reliability and performance. This process ensures that VONR is activated in a manner tailored to the specific configuration and network conditions.

In some embodiments, certain aspects of the techniques described above may be implemented by one or more processors of a processing system executing software. The software comprises one or more sets of executable instructions stored or otherwise tangibly embodied on a non-transitory computer-readable storage medium. The software can include the instructions and certain data that, when executed by the one or more processors, manipulate the one or more processors to perform one or more aspects of the techniques described above. The non-transitory computer-readable storage medium can include, for example, a magnetic or optical disk storage device, solid-state storage devices such as Flash memory, a cache, random access memory (RAM) or other non-volatile memory device or devices, and the like. The executable instructions stored on the non-transitory computer-readable storage medium may be in source code, assembly language code, object code, or other instruction format that is interpreted or otherwise executable by one or more processors.

A computer-readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer-readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is, therefore, evident that the particular embodiments disclosed above may be altered or modified and all such variations are considered within the scope of the disclosed subject matter. Accordingly, the protection sought herein is as set forth in the claims below.

What is claimed is:

1. A method at a user equipment (UE) device of a cellular network, comprising:
monitoring for at least one Voice over New Radio (VoNR) related parameter from the cellular network based on a device configuration implemented by the UE device; and
responsive to the VoNR related parameter and the device configuration, dynamically enabling a VoNR feature for at least a first New Radio (NR) band.

2. The method of claim 1, further comprising:
disabling the VoNR feature in response to the UE device camping on a second NR band.

3. The method of claim 1, wherein monitoring for the at least one VoNR related parameter comprises:
monitoring, upon powering up of the UE device, at least one of one or more network identifiers or band information, and
wherein dynamically enabling the VoNR feature comprises:
responsive to a determination that conditions for enabling the VoNR feature are satisfied based on comparing the at least one of one or more network identifiers or band information to the device configuration, dynamically enabling the VoNR feature.

4. The method of claim 1, wherein dynamically enabling the VoNR feature comprises:
dynamically enabling the VoNR feature only for one or more NR bands supported by at least one specific carrier while excluding one or more NR bands known to have performance issues.

5. The method of claim 4, wherein dynamically enabling the VoNR feature comprises:
dynamically enabling the VoNR feature for multiple supported NR bands when the UE device camps simultaneously on those NR bands.

6. The method of claim 1, further comprising:
responsive to the UE device moving from the first NR band that supports VONR to a second NR band that does not support VONR, disabling the VoNR feature; and
initiating a fallback mechanism.

7. The method of claim 1, further comprising:
re-enabling the VoNR feature when the UE device returns to an NR band that supports VONR.

8. A user equipment device, comprising:
one or more radio frequency (RF) modems configured to wirelessly communicate with at least one network;
one or more processors coupled to the one or more RF modems; and
at least one memory storing executable instructions, the executable instructions configured to manipulate at least one of the one or more processors or the one or more RF modems to:
monitor for at least one Voice over New Radio (VoNR) related parameter from a cellular network based on a device configuration implemented by the UE device; and
responsive to the VoNR related parameter and the device configuration, dynamically enable a VoNR feature for at least a first New Radio (NR) band.

9. The user equipment device of claim 8, wherein the executable instructions are further configured to manipulate the at least one of the one or more processors or the one or more RF modems to:
disable the VoNR feature in response to the UE device camping on a second NR band.

10. The user equipment device of claim 8, wherein the at least one of the one or more processors or the one or more RF modems are configured to monitor for the at least one VoNR related parameter by:
monitoring, upon powering up of the UE device, at least one of one or more network identifiers or band information, and
wherein the at least one of the one or more processors or the one or more RF modems are configured to dynamically enable the VoNR feature by:
responsive to a determination that conditions for enabling the VoNR feature are satisfied based on comparing the at least one of one or more network identifiers or band information to the device configuration, dynamically enabling the VoNR feature.

11. The user equipment device of claim 8, wherein the at least one of the one or more processors or the one or more RF modems are configured to dynamically enable the VoNR feature by:
dynamically enabling the VoNR feature only for one or more NR bands supported by at least one specific carrier while excluding one or more NR bands known to have performance issues.

12. The user equipment device of claim 11, wherein the at least one of the one or more processors or the one or more RF modems are configured to dynamically enable the VoNR feature by:
dynamically enabling the VoNR feature for multiple supported NR bands when the UE device camps simultaneously on those NR bands.

13. The user equipment device of claim 8, wherein the executable instructions are further configured to manipulate the at least one of the one or more processors or the one or more RF modems to:
disable the VoNR feature in response to the UE device moving from the first NR band that supports VONR to a second NR band that does not support VONR; and
initiate a fallback mechanism.

14. The user equipment device of claim 8, wherein the executable instructions are further configured to manipulate the at least one of the one or more processors or the one or more RF modems to:
re-enable the VoNR feature when the UE device returns to an NR band that supports VONR.

15. A method at a user equipment (UE) device of a cellular network, comprising:
monitoring, upon powering up the UE device, at least one of one or more network identifiers or band information broadcast by the cellular network;
comparing at least one of one or more network identifiers or band information to a device configuration implemented by the UE device to determine whether a specific carrier supports Voice over New Radio (VoNR) for one or more specific New Radio (NR) bands;
dynamically enabling at least one VoNR feature in response to determining that the specific carrier supports VONR for the one or more specific NR bands and that the at least one of one or more network identifiers or band information satisfy at least one condition for enabling the VoNR feature; and
disabling the VoNR feature in response to the UE device transitioning to an NR band that does not satisfy the at least one condition for enabling the VoNR feature.
